(19) United States
(12) Patent Application Publication
(10) Pub. No.: US 2009/0225767 A1
(43) Pub. Date: Sep. 10, 2009

(54) NETWORK PACKET CAPTURING METHOD

(75) Inventors: Xian-Guang Song, Tianjin (CN); Xing-Jia Wang, Tianjin (CN); Tom Chen, Taipei (TW); Win-Harn Liu, Taipei (TW)

Correspondence Address: APEX JURIS, PLLC, 12733 LAKE CITY WAY NORTHEAST, SEATTLE, WA, 98125, US

(73) Assignee: INVENTEC CORPORATION, Taipei (TW)

(21) Appl. No.: 12/042,832

(22) Filed: Mar. 5, 2008

(51) Int. Cl. H04L 12/56

(52) U.S. Cl. 370/412

(57) ABSTRACT

A network packet capturing method for capturing a plurality of packets from a physical layer to an application layer by a network server through a network card is described. The packet capturing method includes the following steps. Capture packets by a new application interface (NAPI); set a ring queue in a kernel; provide a hook process for capturing the packets; store the captured packets into the ring queue; and map the packets stored in the ring queue into a memory space of a corresponding application through memory mapping, thereby reducing the number of interrupts of the system and the number of replications during the packets parsing.

### BACKGROUND OF THE INVENTION

1. Field of the Invention

The present invention relates to a network packet capturing method, and more particularly to a packet capturing method for Gigabytes network to reduce the number of interrupts of the system and the number of replications during packets parsing.

2. Related Art

A network analysis tool is generally formed by a packet capture module, a protocol analysis module, a rule match module, and a response processing module. Referring to FIG. 1, it is a schematic view of architecture of a conventional network packet capturing tool. The packet capture module is an important part in the network analysis tool, and the packet-capturing rate may directly affect the performance of the network analysis tool.

Referring to FIG. 2, it is a flow chart of a conventional packet capturing operation. When the network card detects that a packet is received, the network card triggers hardware interrupt, such that the central processing unit (CPU) enters an interrupt handler (Step S210). The CPU adds the data into a buffer area in the interrupt handler of the network card (Step S220) for being called by software interrupt of the operation system. The software interrupt handler replicates the packets to be processed by the CPU to an application at a client (Step S230). Most conventional applications call the functions of recvfrom( ) or recvmsg( ) through an operation system to capture packets. If a packet is captured through such a manner, the packet is needed to be gradually replicated from the physical layer to the application layer for being stored therein.

Finally, after the operation system has processed the software interrupt, the CPU transmits the data into the application layer (Step S240). If a new packet is received during the software interrupt, the operation system executes the hardware interrupt and stops the operations of the software interrupt, as the hardware interrupt has a higher priority than the software interrupt.

If the interrupt frequency is rather high to reach a certain level, and the CPU is busy in processing the hardware interrupt, the upper layer protocol (for example, network layer or transport layer) for processing the packets at this time cannot parse the packets smoothly, but the CPU continuously stores data into the buffer area. Once the buffer area is filled up, the received packets can only be dropped, which is called interrupt livelock.

The problems brought out by interrupt livelock may be solved from two aspects. One aspect is the time for processing interrupt, and the other is the size of the buffer area. If the interrupt time is excessively short, the frequent hardware interrupt of the operation system easily causes interrupt livelock. If the interrupt time is excessively long, the CPU may sometimes have nothing to do and the calculation resources of the CPU are wasted. The other aspect is the size of the buffer area. In theory, the larger the capacity of the buffer area is, the better the effect is. For the network transmission with a large flow rate, as the CPU is required to switch frequently, such a method has a relatively large load, which is not beneficial for the application to receive the packets.

### SUMMARY OF THE INVENTION

Accordingly, the present invention is mainly directed to a network packet capturing method, such that a network server captures a plurality of packets from a physical layer to an application layer, and thus reducing the times for replicating the packets from the physical layer to the application layer.

In order to achieve the above objective, the present invention provides a network packet capturing method, which includes the following steps: capturing packets by a new application interface (New API, NAPI) mechanism; setting a buffer area in a memory; providing a hook process for capturing the packets; storing header information into the buffer area; and accessing the header information stored in the buffer area by means of memory mapping.

The present invention utilizes a ring queue in a kernel space, meanwhile stores the captured packets into the ring queue, and then accesses the packets data stored in the ring queue by means of memory mapping, so as to reduce the times for replicating the packets from the physical layer to the application layer for storage.

### BRIEF DESCRIPTION OF THE DRAWINGS

The present invention will become more fully understood from the detailed description given herein below for illustration only, which thus is not limitative of the present invention, and wherein:

FIG. 1 is a schematic view of architecture of a conventional network packet capturing tool;

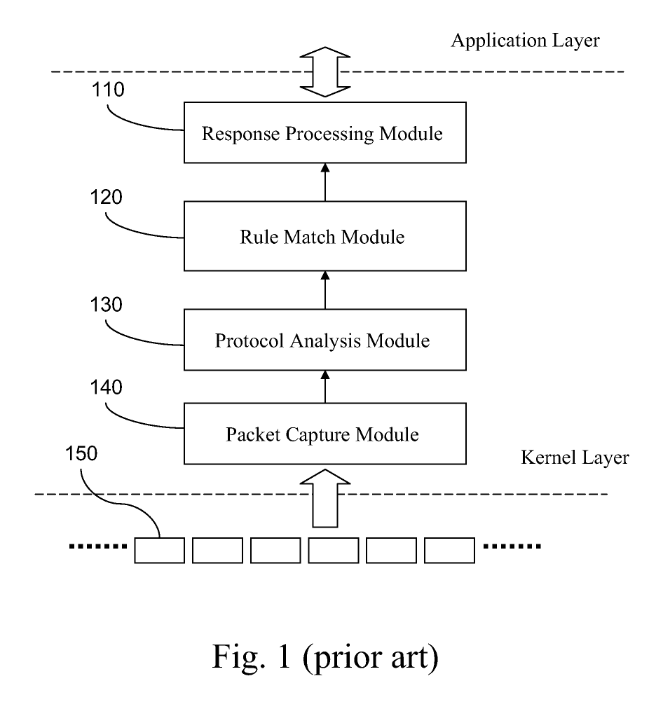

FIG. 2 is a flow chart of a conventional packet capturing operation;

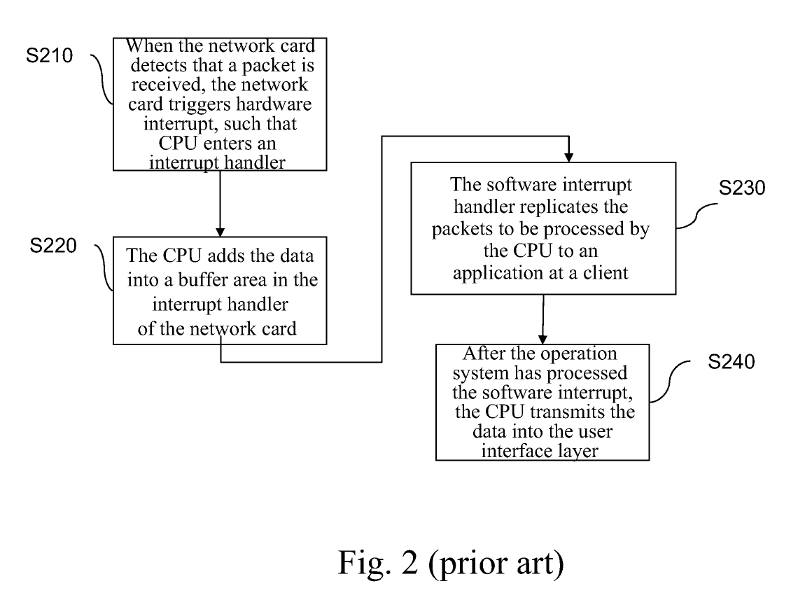

FIG. 3 is a schematic flow chart of operations of the present invention; and

FIG. 4 is a schematic view of operations for the elements of the present invention.

### DETAILED DESCRIPTION OF THE INVENTION

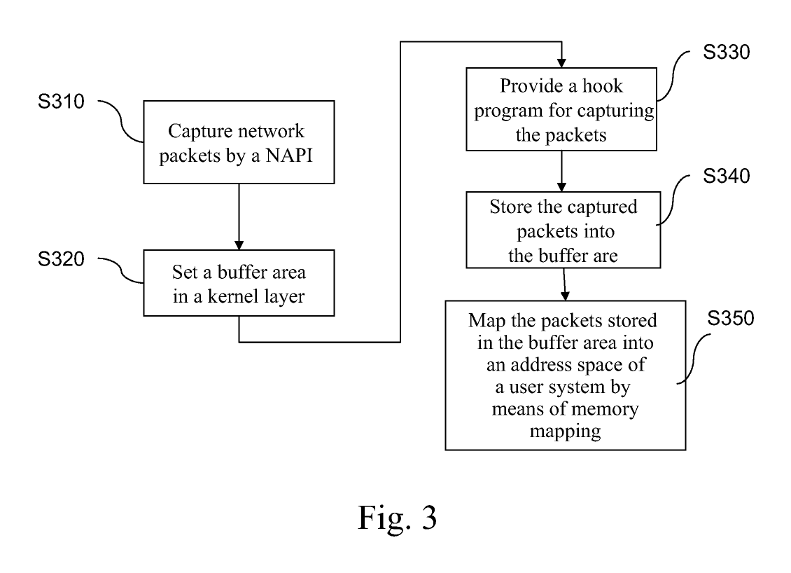

The present invention provides a network packet capturing method, in which a plurality of packets is read from a network physical layer to an application layer through a network card. Referring to FIG. 3, it is a schematic flow chart of operations of the present invention. The process for reading the packets of the present invention includes the following steps: capturing network packets by a new application interface (NAPI) mechanism (Step S310); setting a buffer area in a kernel (Step S320); providing a hook process for capturing the packets (Step S330); storing the captured packets into the buffer area (Step S340); and mapping the packets stored in the buffer area into an address space of a user system by means of memory mapping (Step S350).

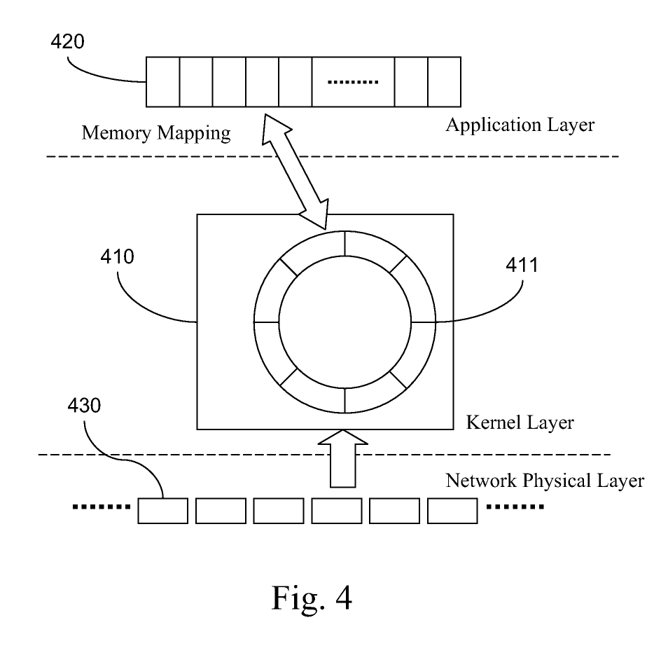

Referring to FIG. 4, it is a schematic view of operations for the elements of the present invention. Referring to the flow chart in FIG. 3 together, in the present invention, a new application interface (NAPI) is utilized to capture network packets, that's because the interrupt frequency of a network card 410 must be reduced, in order to solve the problem of interrupt livelock of the system. The core concept of the NAPI is to awake the service program for receiving data by utilizing the interrupt, and then to poll whether the data is required to be read or not. The NAPI aims at reducing the number of generated interrupts, especially for a great number of short data packets. In this way, the operation system does not spent much time on saving and recovering the interrupt context, but has more time to process data transmission on the physical layer.

Once beginning to capture the packets, the network card 410 stores the captured packets into a buffer area of a ring queue 411. The ring queue 411 takes a memory page as a unit and is formed by a plurality of continuous memory pages. One memory page is formed by a plurality of memory frames. The network card 410 stores the captured packets in the memory frames respectively.

Although the size of the memory frame is not necessarily the same as that of the captured packet, if the size of the packet is greater than that of the memory frame, the part of the data at the tail of the packet that exceeds the capacity of the memory frame is cut off, and the remaining part of data is replicated into the memory frame. Additionally, merely the header information of the packet may be stored.

Next, the packets 430 stored in the ring queue 411 are accessed by means of memory mapping. The packets 430 stored in the ring queue 411 are mapped into a memory space used by an application. It should be especially noted that, the application in this step refers to an application using the packet capturing method of the present invention, as well as an address space assigned to the application of an application layer. The memory mapping mainly aims at reducing the expense on reading and writing documents, allocating a large memory space, and sharing the memory data when the application is performed. In this way, the operation system does not need to frequently replicate packets 430 from the physical layer into the application layer.

The application provides two sets of corresponding vector indexes according to an initial address of the ring queue 411 obtained after the memory mapping. The two sets of vector indexes are respectively disposed in the kernel and the application layer of the system. The vector index in the kernel of the system is provided for being used by a soft interrupt processing function, which sequentially replicates the packets in the queue to be processed into the ring queue 411, till the ring queue 411 is filled up. The other vector index in the application layer is provided for being used by the application and it is used to process the packets in the ring queue 411, till the ring queue 411 has no new packets 430.

The present invention utilizes the ring queue 411 in the network card 410 and stores the captured packets in the ring queue 411, then accesses the packets 430 stored in the ring queue 411 by means of memory mapping, so as to reduce the times for replicating the packets 430 from the physical layer to the application layer for storage.

What is claimed is:

1. A network packet capturing method, wherein a network server is used to perform the following steps, such that an application executed by the network server captures a plurality of packets from a network physical layer to an application layer through a network card, the packet capturing method comprising:
capturing the packets by a new application interface;
setting a buffer area in the network card;
providing a hook process for capturing the packets;
storing the captured packets in the buffer area; and
mapping the packets stored in the buffer area into a memory space of a corresponding application through a memory mapping process.

2. The network packet capturing method as claimed in claim 1, wherein the method of capturing the packets further comprises:
capturing a header information of the packets; and
mapping the header information stored in the buffer area into a memory space of a corresponding application.

3. The network packet capturing method as claimed in claim 2, wherein the application layer accesses the header information stored in the memory of the system.

4. The network packet capturing method as claimed in claim 1, wherein the buffer area is formed by a ring queue.
